(19) United States
(12) Patent Application Publication
(10) Pub. No.: US 2017/0320239 A1
(43) Pub. Date: Nov. 9, 2017

(54) Apparatus and Method for Reducing the Size of Fiber Composite Materials

(71) Applicant: Mirko Winter, Chemnitz (DE)

(72) Inventor: Mirko Winter, Chemnitz (DE)

(21) Appl. No.: 15/522,301

(22) PCT Filed: Oct. 25, 2015
(86) PCT No.: PCT/DE2015/100447

§ 371 Date: Apr. 27, 2017

(30) Foreign Application Priority Data
Oct. 27, 2014 (DE) 20 2014 105 123.6

(51) Int. Cl. B29B 17/02; B29B 17/04; B02C 2/10; B29K 105/06

(52) U.S. Cl. CPC B29B 17/0206; B29B 17/0412; B02C 2/10; B29K 2105/06; B29B 2017/0217

(57) ABSTRACT

The invention relates to an apparatus and a method for reducing the size of fiber composite materials, characterized in that means (6) for mechanically abrading an embedding matrix from fibers is provided, the mechanical abrasion of the embedding matrix from the fibers being performed using a rotational movement. In the method of the invention, an embedding matrix is mechanically abraded from the fibers by the means (6) using a rotational movement of the means (6) that are put in place.

### CROSS REFERENCE TO RELATED APPLICATIONS

This application is the U.S. national stage of International Application No. PCT/DE2015/100447, filed on 2015 Oct. 25. The international application claims the priority of DE 202014105123.6 filed on 2014 Oct. 27; all applications are incorporated by reference herein in their entirety.

### BACKGROUND

The invention relates to an apparatus and a method for reducing the size of and for recycling fibre composite materials.

Various methods are known from the prior art for separating fibre composite materials in the course of disposal and recycling.

EP 0 797 496 B1 discloses a chemical separation of fibre composite materials, in which the fibres are detached from the surrounding matrix by action of ozone. Chemical methods are often very complex, the employed chemicals are mostly expensive to purchase and dispose of, and the obtained fibres and matrix particles require extensive aftertreatment before they can be supplied for further use.

Previously known mechanical separation methods for separating matrix material and fibres are mostly based on the fracturing of the fibre-plastic structures by means of shredders, rollers or pulverisers.

EP 0 443 051 A1 for example describes the mechanical fracturing of a composite structure consisting of glass fibres and polyester by means of an impact mechanism, which is preferably a hammer mill. A reduction in size of fibre composite materials by means of a hammer mill is also proposed in WO 93/05883. In this case, subsequent separation of fibres and matrix particles occurs by means of a screen and an air flow.

In JP 2003 071839 A, the fibre composite material to be reduced in size is shredded at first and subsequently ground by means of a screen-type mill and the contained fibres and matrix particles are separated by means of an air flow. The material is usually finely ground in a screen-type mill and pressed through a screen. Fracturing of the fibres cannot be excluded in this case.

A reduction in size by rollers is described for example in DE 10 2004 017 441 A1 or also in EP 1 454 673 B1.

In conventional mechanical separating methods the breaking away of the fibres occurs, so that they are no longer present for reuse in an intact manner. Especially frequently used glass fibres are broken or bent to a very high extent. A renewed use of the fibres offers considerable financial advantages as a result of the relatively high market price for fibres which are usually used in fibre composite materials.

### SUMMARY

The invention relates to an apparatus and a method for reducing the size of fiber composite materials, characterized in that means (6) for mechanically abrading an embedding matrix from fibers is provided, the mechanical abrasion of the embedding matrix from the fibers being performed using a rotational movement. In the method of the invention, an embedding matrix is mechanically abraded from the fibers by the means (6) using a rotational movement of the means (6) that are put in place.

### DETAILED DESCRIPTION

It is therefore the object of the invention to provide an apparatus and a method which detaches the fibres from the fibre composite material as carefully as possible, so that both the fibres and also the embedding matrix can be used again.

This object is achieved by the features of claims 1 and 9 by an apparatus for reducing the size of fibre composite materials, wherein in accordance with the invention means are present in a receptacle for mechanically abrading a matrix of the fibre composite material from the fibres of the fibre composite material, wherein the mechanical abrasion of the matrix from the fibres occurs by a relative rotational movement.

In a preferred embodiment, two rotationally symmetrical elements which are mounted in each other are contained in the apparatus in accordance with the invention, of which at least one is formed in a conical manner and of which at least one is rotatably mounted about a longitudinal axis, wherein a feed opening is arranged at one end of the rotationally symmetrical elements and an outlet opening at the opposite end of the rotationally symmetrical elements, and the distance between the two rotationally symmetrical elements at the outlet opening is smaller than at the feed opening.

A tapering of the distance between the two rotationally symmetrical elements from the feed opening to the outlet opening is preferably achieved by different cone angles of the outer and inner rotationally symmetrical element.

A grinding gap is produced by the arrangement in accordance with the invention between the two rotationally symmetrical elements, into which the fibre composite materials, which can be subjected to previous preliminary reduction in size, are introduced through the feed opening. By a rotation of one of the two or both rotationally symmetrical elements about their longitudinal axis, a careful and gradual abrasion of the matrix material from the fibres occurs. Since the distance between the two rotationally symmetrical elements at the outlet opening is smaller than at the feed opening, a fine grinding of the grinding material occurs in the lower region of the apparatus.

The outlet opening and the feed opening are preferably arranged directly in the intermediate space between the two rotationally symmetrical elements and/or as circumferential openings in the outer and/or inner rotationally symmetrical element.

In accordance with the invention, means for the mechanical abrasion of a matrix of the fibre composite material from the fibres are present in the apparatus. In a preferred embodiment, these means are formed as elevations on at least one of the two rotationally symmetrical elements on the surface facing the respective other rotationally symmetrical element. The elevations are preferably strips or rods which are preferably oriented in the longitudinal direction of the rotationally symmetrical elements. It is also possible to provide the aforementioned means as semi-spheres on the walls of the rotationally symmetrical elements.

The material (which can be previously subjected to a reduction in size) introduced via the feed opening is further reduced in size by “rubbing along” the elevations of the apparatus, or the plastic material (the matrix) is gradually abraded and removed from the fibres and the reduced or partly reduced material is moved in the direction towards the outlet opening and further continuously reduced in size by the reducing grinding gap, or the matrix/plastic in which the fibres are embedded is continuously abraded from the fibres.

A fracturing or grinding of the fibres advantageously does not occur by means of the means for mechanical abrasion in accordance with the invention. Instead, a careful abrasion of the matrix/plastic from the fibres occurs, which allows reusing both the fibres as well as the matrix particles.

In a further preferred embodiment, the two rotationally symmetric elements are displaceable relative to each other in the longitudinal direction. The distance between the two rotationally symmetrical elements can be varied in this manner and can be set individually depending on the material properties of the fibre composite material to be separated.

In a further preferred embodiment, at least one of the two rotationally symmetrical elements is perforated in the region above the outlet opening. The perforation is selected at a size which allows the separated matrix particles to pass, but not the separated fibres. The matrix particles are preferably removed by means of an external suction apparatus through the perforation from the region between the two rotationally symmetrical elements. A simple screening of the matrix particles occurs alternatively.

If such a perforation is not present, the fibres and the matrix particles leave the outlet opening in separate form, but simultaneously. In this case, a downstream separating process, e.g. by air separation, is necessary.

In a preferred embodiment, the two rotationally symmetrical elements are pivotably arranged in a frame with respect to a horizontal plane. The apparatus is advantageously pivotably arranged at an angle of 0° to 45°. The passage velocity of the grinding material from the feed opening to the outlet opening can be varied in this manner.

The outlet opening preferably lies beneath the feed opening with respect to height, so that the reduced fibre composite material is conveyed in the grinding gap by gravity in the downward direction towards the outlet opening.

The invention offers the possibility of especially effective recycling of fibre composite materials. The fibres are not broken down, fractured or bent as in the known methods, but instead the embedding matrix is carefully abraded from the fibres. This careful abrasion not only allows reusing the detached matrix particles, but also provides considerably more intact fibres than provided by current methods. The apparatus in accordance with the invention allows reclaiming up to 90% of the fibres which are free from matrix particles. Current methods have not yet allowed the reclaiming of fibres without any change to the fibre properties.

A method for reducing the size of fibre composite materials in the apparatus in accordance with the invention is also provided in accordance with the invention. In this process, the material to be reduced in size is introduced through the feed opening into the apparatus in accordance with the invention. Material that was already previously reduced in size is preferably introduced. The material to be reduced in size is then ground in the grinding gap by a relative rotational movement of the two rotationally symmetrical elements, wherein careful abrasion of the matrix particles from the fibres is carried out by providing the lowest possible stress on the fibres.

### BRIEF DESCRIPTION OF THE DRAWINGS

The invention will be explained below in closer detail by reference to an embodiment and the associated drawings without being limited thereto, wherein:

FIG. 1 shows a sectional view of an outer rotationally symmetrical element in accordance with the invention in the region which contains means for mechanical abrasion;

FIG. 2 shows a sectional view of an outer rotationally symmetrical element in accordance with the invention in the region which contains a perforation;

FIG. 3 shows a schematic view of an inner rotationally symmetrical element in accordance with the invention;

FIG. 4 shows a sectional view of an inner rotationally symmetrical element in accordance with the invention;

FIG. 5 shows a schematic sectional view of an apparatus in accordance with the invention;

FIG. 6 shows a schematic view of an apparatus in accordance with the invention which is arranged on a frame;

FIG. 7 shows a principal view of the angles of the apparatus;

FIG. 8 shows a principal view of the means 6.

### DETAILED DESCRIPTION OF THE PREFERRED EMBODIMENTS

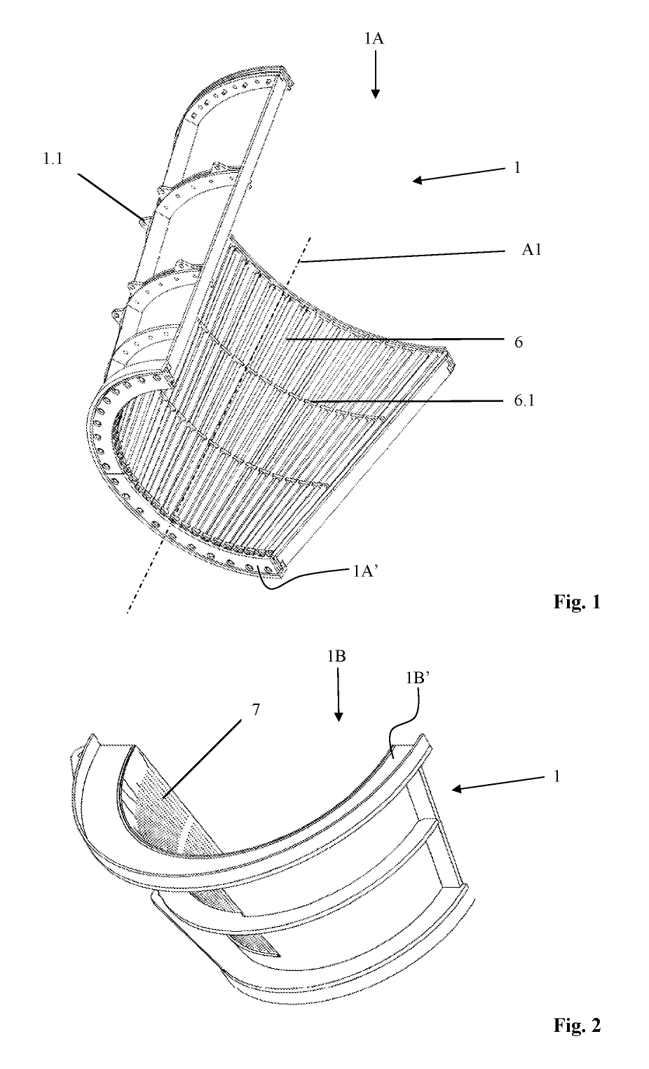

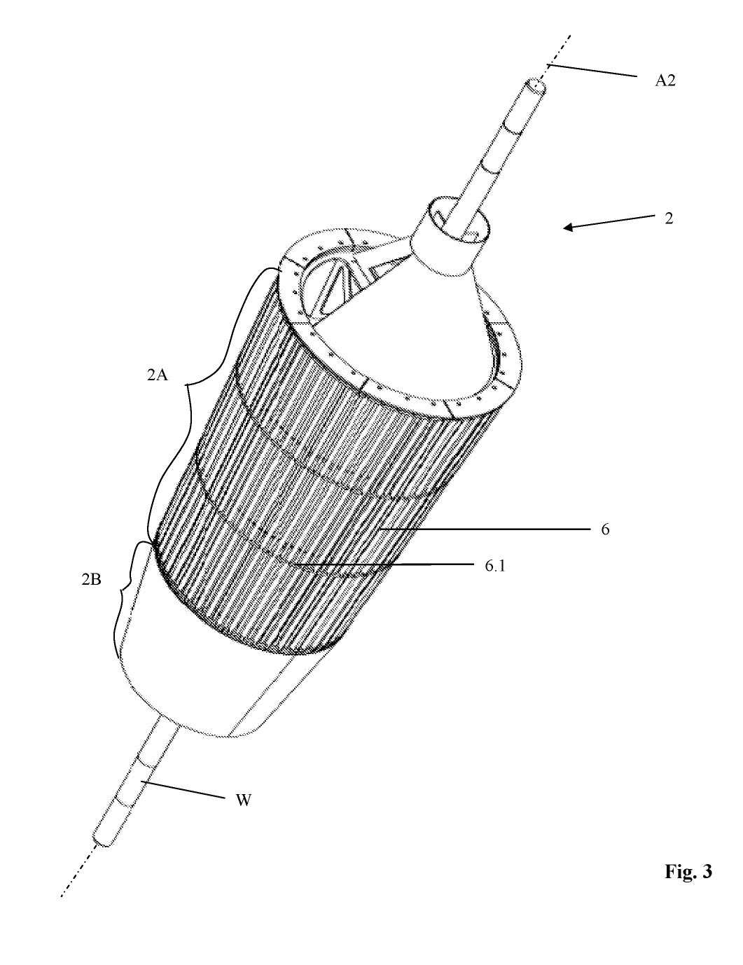

FIG. 1 shows a sectional view of an outer rotationally symmetrical element 1 in accordance with the invention in a first region 1A which contains means for mechanical abrasion 6. In this respect, means for mechanical abrasion are present on the inner side of the outer rotationally symmetrical element 1 (designated below as outer jacket) in the direction towards the longitudinal axis A1, which means are formed in this case in form of strips 6. Said strips 6 are preferably distributed over the entire circumference of the rotationally symmetrical element 1, especially in equal distances. The strips 6 are fastened by means of retainers 6.1 to the end regions and in between to the inner side of the outer jacket. The outer jacket 1 is fastened to or received by a frame (not shown) by means of several retainers 1.1 on the outer region. The outer jacket 1 is substantially formed in a conical way, wherein a second region 1B of the outer jacket 1 having a perforated region (see FIG. 2) is attached to the side 1A′ of the first region 1A which has the smallest diameter (situated below in the image plane).

FIG. 2 shows a three-dimensional partial sectional view of a second region 1B in form of an outlet region of the outer jacket 1 in accordance with the invention, which contains a perforation 7 in a circumferential region. Said outlet region 1B of the outer jacket 1 is attached with the side 1B′ at which it has the greatest diameter (situated at the top in the image plane) to the portion of the outer jacket 1 shown in FIG. 1, which comprises the means for mechanical abrasion 6, on the side 1′ with the smallest diameter.

The outer rotationally symmetrical element 1, i.e. the outer jacket 1, is thus composed of the first region 1A which contains the strips 6 on the inner side and of the second region 1B, i.e. the outlet region, which contains the perforation 7. The first region 1A and the second region 1B preferably have the same cone angle.

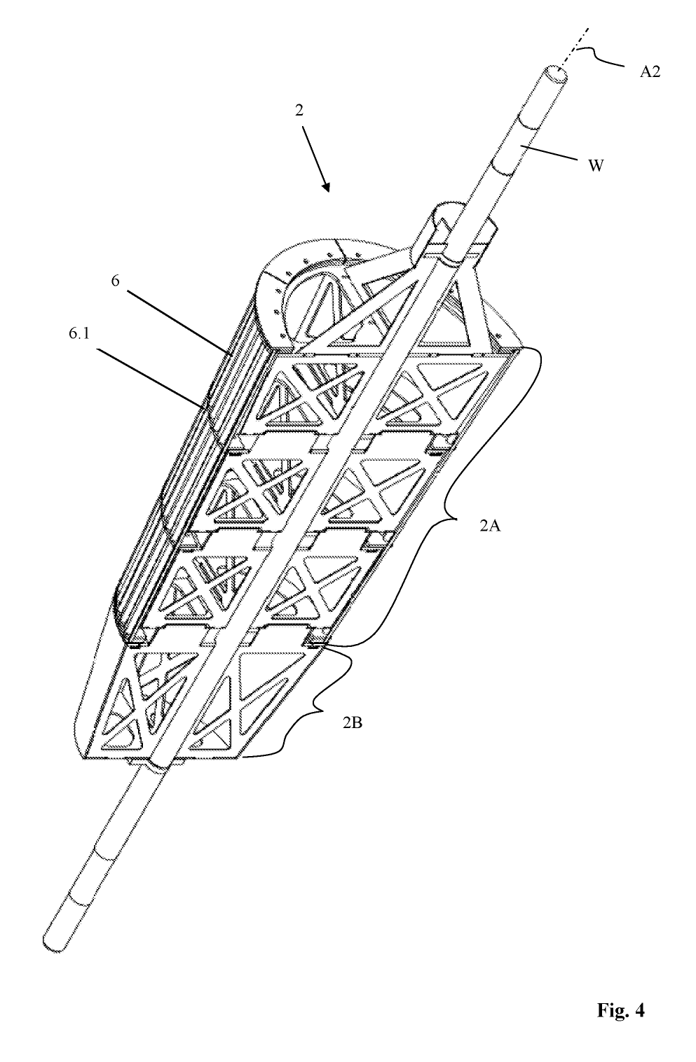

FIG. 3 shows a schematic three-dimensional illustration and FIG. 4 shows a sectional view of an inner rotationally symmetrical element 2 in accordance with the invention. Strips 6 as means for mechanical abrasion are also present on the inner rotationally symmetrical element 2 in a first region 2A, but on the outer circumference. Similar to the strips 6 on the outer rotationally symmetrical element/outer jacket 1, the strips 6 of the inner rotationally symmetrical element can be present over the entire circumference, especially at equal distances, wherein they extend along the longitudinal axis A2 of the inner rotationally symmetrical element 2. The strips 6 are also fastened by means of retainers 6.1 to the inner rotationally symmetrical element 2, but on the outer circumference. In a second region 2B, which corresponds with the perforation of the outer rotationally symmetrical element 1, the inner rotationally symmetrical element 2 does not comprise any means for mechanical abrasion 6 of an inner rotationally symmetrical element in accordance with the invention. The first region 2A of the inner rotationally symmetrical element 2 is also formed conically, but has a smaller cone angle than the outer jacket 1. The second region 2B is also formed conically, wherein the cone angle of the second region 2B substantially corresponds to the cone angle of the outer jacket.

The second rotationally symmetrical element 2 is connected in a torsion-proof manner to a rotational shaft W which leads through said element and which protrudes beyond the inner rotationally symmetrical element at the two ends and is rotationally mounted at said two ends. The shaft W is rotationally driven by means of a drive (not shown).

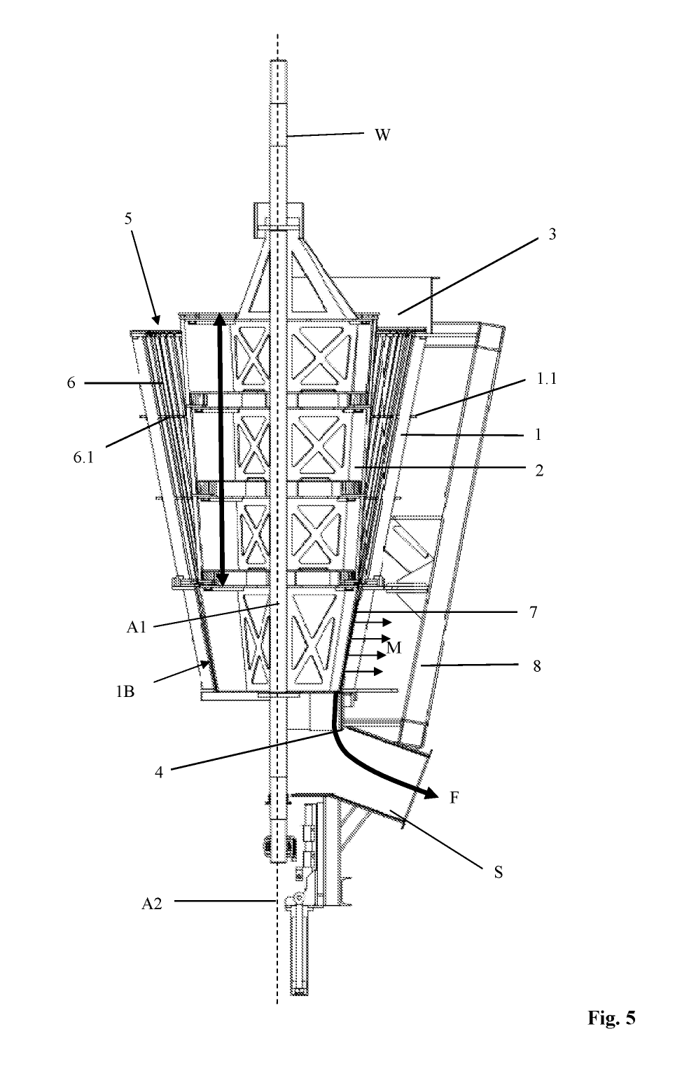

FIG. 5 shows a schematic view of an apparatus in accordance with the invention in a cross-sectional view. Whereas the outer rotationally symmetrical element (=outer jacket) 1 is mounted in a rotationally rigid manner in a frame 8, the inner rotationally symmetrical element 2 is rotatably mounted by means of the shaft W about its longitudinal axis A2. The longitudinal axes A1 and A2 are in alignment. The shaft W is driven by a drive motor (not shown), optionally by using a gear. A grinding gap 5 is formed between the outer 1 and the inner rotationally symmetrical element 2, into which the fibre composite material to be reduced in size is introduced via the feed opening 3. Strips 6 extending in the longitudinal direction are disposed both on the inner 2 and also on the outer rotationally symmetrical element 1, which strips 6 are fastened in respective retainers 6.1. On both rotationally symmetrical elements, the strips 6 extend over the entire circumference (on the inner circumference in the outer jacket 1 and on the outer circumference in the inner element 2) and are only indicated in FIG. 3. The fibre composite materials present in the grinding gap 5 are carefully abraded by the rotational movement of the inner rotationally symmetrical element. The rotational speed of the inner rotationally symmetrical element 2 preferably only lies between 2 to 20 rpm. The fibres and matrix particles which are now separately present enter the outlet region 1B with the perforated region 7 in which the outer rotationally symmetrical element 1 is perforated, i.e. it comprises a plurality of breakthroughs. The perforation 7 is chosen with a size which allows passage of the matrix particles but not the fibres. The matrix particles M are removed or extracted by suction from the grinding gap 5 through the perforation 7, which is illustrated by the numerous arrows with continuous lines. The fibres F that were not extracted by suction leave the grinding gap 5 through the outlet opening 4 and reach an outlet shaft S, which is indicated by the bold dashed arrow. Both the fibres F and also the matrix particles M can subsequently be supplied for further use.

The inner rotational symmetrical element 2 can be adjusted along its longitudinal axis A2 for setting the grinding gap 5. If it is adjusted in the direction of the outlet opening 4, the grinding gap 5 becomes smaller, and if it is adjusted in the direction towards the feed opening 3 the grinding gap 5 becomes larger. The adjustability is indicated by the double arrow in bold.

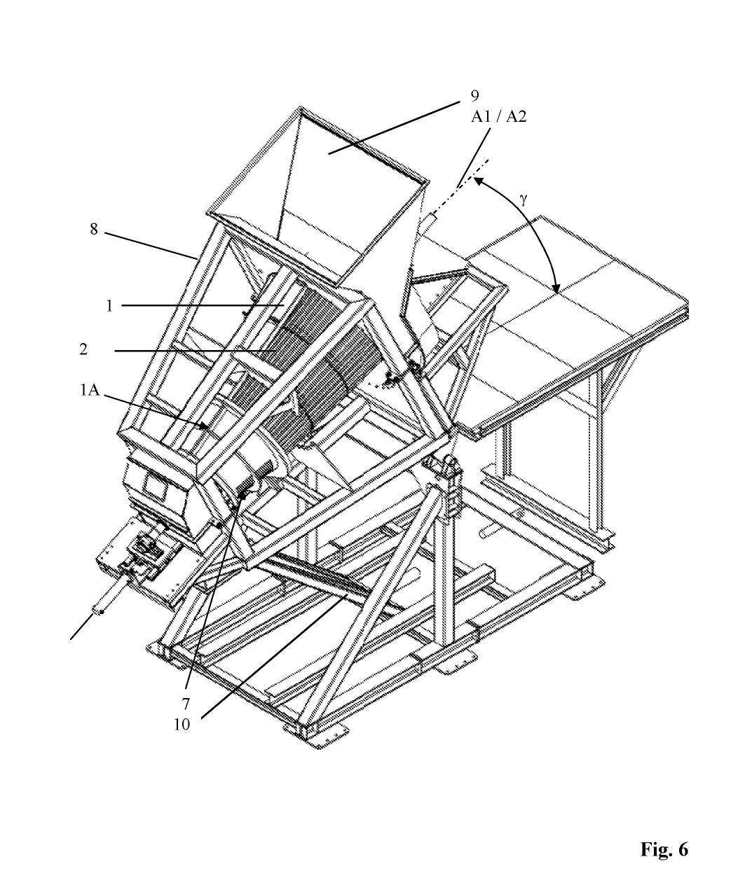

FIG. 6 schematically shows an apparatus in accordance with the invention which is arranged in a frame. The outer rotationally symmetrical element 1 and the inner rotationally symmetrical element 2 are pivotably mounted in the frame 8, so that the mutually aligned longitudinal axes A1, A2 are either horizontally oriented during the reduction process or are inclined up to an angle of inclination □ of approximately 45°. The pivoting is enabled by a means for pivoting 10 which can be driven hydraulically for example. For the purpose of easier introduction of the fibre composite material and discharge of the separated material, an auxiliary means such as a feed channel 9 can be attached to the frame close to the feed opening or an outlet shaft (not shown) close to the outlet opening. The perforated region 7, which is followed by a suction unit (not shown), preferably faces in the downward direction.

The fibre composite material to be reduced in size, which can optionally be present in a pre-comminuted manner, is introduced according to the method through the upper feed channel 9. The material to be reduced in size moves downwardly as a result of gravity, where the grinding gap 5 tapers increasingly by the conical shape of the outer jacket and the inner rotationally symmetrical element. As a result of a relative rotational movement of the two rotationally symmetrical elements 1, 2, the matrix of the fibre composite material is carefully abraded from the fibres between the strips present on the rotationally symmetrical elements. The thus comminuted parts sink downwardly into the narrower region of the grinding 5 where further abrasion of the matrix particles remaining on the fibres occurs. In the bottom region of the grinding gap 5, the fibres and the abraded matrix particles reach a region 7, in which the outer rotationally symmetrical element 1 is perforated. The abraded matrix particles are separated/extracted by suction through the perforation 7, while the remaining fibres in the grinding gap 5 travel further downwardly and leave the apparatus in accordance with the invention through the outlet opening 4. If no perforated region 7 is present, the matrix particles and the fibres leave the apparatus in accordance with the invention in separate form jointly through the outlet opening 4 and the outlet shaft S.

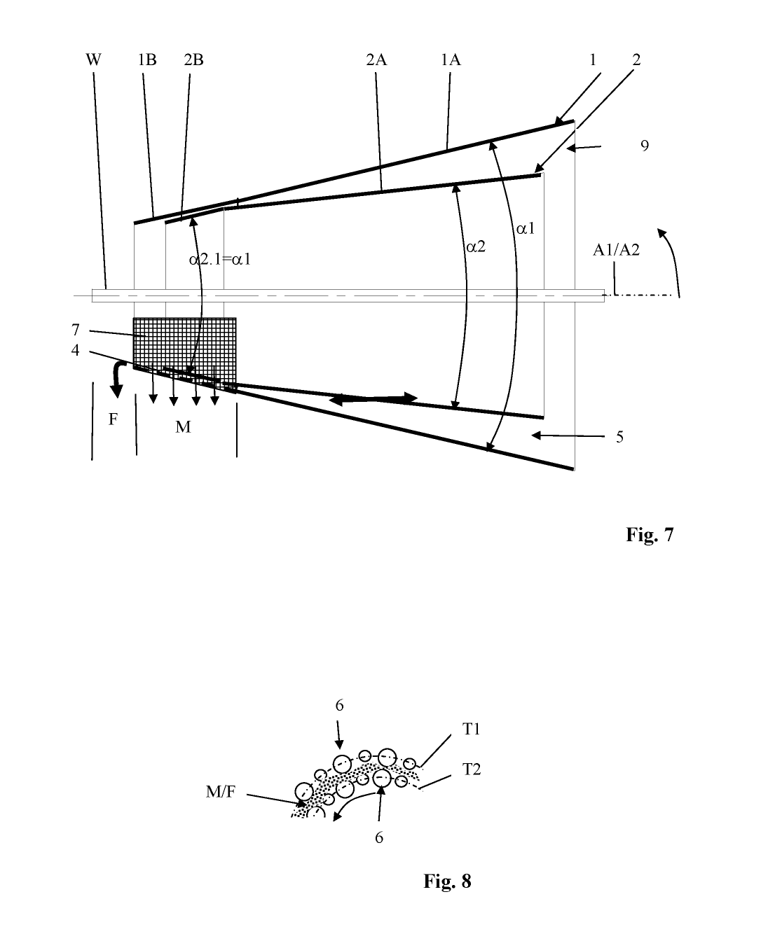

FIG. 7 shows a principal view of the outer jacket 1 and the inner rotationally symmetrical element 2 with the cone angles. The outer jacket 1 is formed by the first region 1A and the second region 1B, which both have a first cone angle □1 which lies between 20 and 30°. The inner rotationally symmetrical element 2 which is made to rotate via the shaft W and a drive (not shown) comprises a first region 2A and a second region 2B. The first region 2A has a second cone angle □2 which is lower than □□1 and preferably lies between 7 and 15°. The second region 2B is provided with a third cone angle □2.1, which substantially corresponds to the first cone angle □□1.

The first region 1A of the outer jacket 1 is provided with elevations/strips (not shown) on its inner diameter and the first region 2A of the inner rotationally symmetric element 2 is provided with elevations/strips (not shown) on its outer diameter. The second region 1B of the outer jacket is provided with a perforation 7 in the downwardly facing region and the second region 2B of the inner rotationally symmetric element 2 is in alignment at least in sections with the second region 1A. The second regions 1B, 2B are formed in a substantially smooth manner on their mutually facing sides.

A grinding gap 5 is present between the first and second rotationally symmetrical element 1, 2. The grinding matrix particles M are removed by suction through the perforation by means of a suction unit (not shown) and the fibres F are removed via the outlet opening 4.

The distance between the rods/means (not shown) of the outer jacket and the rods/means of the inner rotationally symmetrical elements determines the grinding gap 5 and decreases in size continuously in the direction towards the outlet opening 4. The grinding gap 5 which is best suited for the fibre composite material to be reduced in size can be determined by reference tests. It is advantageous that the inner rotationally symmetrical element can be adjusted along its longitudinal axis A2 relative to the outer jacket 1, which is indicated by the double arrow in bold print. As a result of this adjustment, the grinding gap 5 is simply enlarged by the conical shape of the outer jacket 1 and the inner rotationally symmetrical element 2 when the inner rotationally symmetrical element 2 is adjusted in the direction towards the feed channel 9 and is reduced in size when the inner rotationally symmetrical element is adjusted in the direction towards the outlet opening 4. The outlet opening 4 is sealed when the non-designated outer diameter of the second region 2B of the inner rotational symmetrical element 2 rests on the non-designated inner diameter of the second region 1B of the outer jacket 1.

FIG. 8 shows a principal diagram of the arrangement and the formation of the means for mechanical abrasion 6. The means 6 are shown here in the shape of round rods. The rods/means 6 have an alternating small and large diameter. The smaller diameter preferably lies between 3 and 15 mm, the larger diameter between 5 and 30 mm. It is also possible to use rods with greater or smaller diameters. The rods/means 6 of the outer jacket are fastened at the upper end for example on a first pitch circle T1 and the rods/means 6 of the inner rotationally symmetrical element at its upper end for example on a second pitch circle T2, so that the centre of each rod (centre 6) rests on the respective pitch circle T1, T2. This leads to differences in height between which the material to be reduced in size consisting of matrix particles M and fibres F is conveyed during the rotational movement of the inner rotationally symmetric element along said element and is crushed/ground. The difference in the diameter of the rods, which is most beneficial for a specific material, can be determined by preliminary tests.

The separated and extracted fibres F can then be used again as high-value raw material for the production of fibre-reinforced plastic materials. The matrix particles M which consist of plastic can also be reused.

### LIST OF REFERENCE NUMERALS

1 Outer rotationally symmetrical element—outer jacket

1.1 Retainer for the outer rotationally symmetrical element

1A First region with means for mechanical abrasion

1A′ Side of the outer jacket with the smallest diameter

1B Second region=outlet region with perforation

1B′ Side of the outlet region the greatest diameter

2 Inner rotationally symmetrical element

2A First region with means for mechanical abrasion

2B Second region

3 Feed opening

4 Outlet opening

5 Grinding gap

6 Means for mechanical abrasion/elevations/strips

6.1 Retainer for the means for mechanical abrasion

7 Perforated region

8 Frame

9 Feed channel for feeding the material

10 Means for pivoting the apparatus in accordance with the invention

A1 Longitudinal axis of the outer jacket

A2 Longitudinal axis of the inner rotationally symmetrical element

M Matrix particles

F Fibres

S Outlet shaft

W Shaft

α1 First cone angle

α2 Second cone angle

α2.1 Third cone angle

γ Angle of inclination

1-10. (canceled)

11. An apparatus for reducing the size of fibre composite materials, wherein means (6) are present for the mechanical abrasion of an embedding matrix of fibres, wherein the mechanical abrasion of the embedding matrix from the fibres occurs by a rotational movement, wherein the apparatus comprises two rotationally symmetrical elements (1, 2) mounted in each other, which are pivotably arranged with respect to a horizontal plane in a frame (8).

12. The apparatus according to claim 11, wherein of the two rotationally symmetrical elements (1, 2) mounted in each other at least one is formed in a cone-shaped manner and at least one is rotatably mounted about a longitudinal axis, wherein a feed opening (3) is arranged at one end of the rotationally symmetrical elements (1, 2) and an outlet opening (4) at the opposite end of the rotationally symmetrical elements (1, 2), and wherein the distance (5) between the two rotationally symmetrical elements is narrower at the outlet opening (4) than at the feed opening (3).

13. The apparatus according to claim 12, wherein the outlet opening (4) and the feed opening (3) are arranged in the intermediate space (5) between the two rotationally symmetrical elements (1, 2) and/or as circumferential openings in the outer (1) and/or in the inner (2) rotationally symmetrical element.

14. The apparatus according to claim 11, wherein elevations (6) are attached as means (6) for mechanical abrasion on at least one of the two rotationally symmetrical elements (1, 2) on the surface facing towards the respective other rotationally symmetrical element.

15. The apparatus according to claim 14, wherein the elevations (6) are preferably strips or rods oriented in the longitudinal direction of the rotationally symmetrical elements (1, 2).

16. The apparatus according to claim 11, wherein the two rotationally symmetrical elements (1, 2) are displaceable relative to each other in the longitudinal direction for varying the distance between the two rotationally symmetrical elements (1, 2).

17. The apparatus according to claim 11, wherein at least one of the two rotationally symmetrical elements (1, 2) is perforated in a region (7) above the outlet opening (4).

18. A method for reducing the size of fibre composite materials in an apparatus according to claim 11, wherein means (6) carry out mechanical abrasion (6) of an embedding matrix from the fibres (F) by a rotational movement.

19. The method according to claim 18, wherein the following steps are carried out:
a) introduction of the fibre composite material through a feed opening into a grinding gap (5) of the apparatus, which is formed between two rotationally symmetrical elements (1, 2) mounted in each other;
b) subjecting at least one of the rotationally symmetrical elements (1, 2) to a rotational movement or subjecting both rotationally symmetrical elements (1, 2) to a relative rotational movement, as a result of which the fibre composite material is abraded into matrix particles (M) and fibres (F), and either
c) separation of matrix particles (M) and fibres (F) of the fibre composite material by means (6) in the apparatus, or
d) joint discharge of the separately present matrix particles (M) and fibres (F) via the outlet opening (4) and downstream separation of matrix particles (M) and fibres (F).
